(19) United States
(12) Patent Application Publication
(10) Pub. No.: US 2003/0094514 A1
(43) Pub. Date: May 22, 2003

(54) Fuel injecton and method for adjustment thereof

(76) Inventor: Heinz Luft, Hirschaid (DE)

Correspondence Address: KENYON & KENYON, ONE BROADWAY, NEW YORK, NY, 10004, US

(21) Appl. No.: 10/089,668

(22) PCT Filed: Jul. 18, 2001
(86) PCT No.: PCT/DE01/02705

(30) Foreign Application Priority Data
Aug. 2, 2000 (DE) 100 37 571.5

(51) Int. Cl. F02M 59/00

(52) U.S. Cl. 239/533.9; 239/533.2; 239/585.1; 239/585.4; 239/585.5

(57) ABSTRACT

A fuel injector (1) for fuel injection systems of internal combustion engines, in particular for direct injection of fuel into the combustion chamber of an engine, having an actuator (10), a valve needle (3) which is mechanically linked to the actuator (10) and is acted upon by a restoring spring (23) in a closing direction, for actuation of a valve closing body (4), which together with a valve seat face (6) forms a sealing seat, and having a sleeve (24) which pre-stresses the restoring spring (23). An adjusting body (40) is situated adjustably in the sleeve (24) so that a fuel amount flowing through the fuel injector (1) per unit of time is a function of the position of the adjusting body (40) in the sleeve (24).

### BACKGROUND INFORMATION

The present invention is based on a fuel injector according to the preamble of claim 1 and a method of adjusting a fuel injector according to the preamble of claim 11.

German Patent Application 40 23 828 A1 describes a fuel injector and a method of adjusting a fuel injector. To adjust the amount of fuel to be delivered during the opening and closing operation of the electromagnetically operable fuel injector, a magnetically conductive material, e.g., in the form of a powder which alters the magnetic properties of the internal pole is introduced into a blind hole, and thus the magnetic force is varied until the actual measured flow rate of the medium corresponds to the predetermined setpoint flow rate.

Similarly, German Patent Application 40 23 826 A1 describes the insertion of an equalizing bolt into a blind hole of an internal pole having a recess on its periphery, inserting it to the extent that the actual measured amount corresponds to the predetermined setpoint amount, and thus varying the magnetic force until this is achieved.

German Patent Application 195 16 513 A1 also describes a method of adjusting the dynamic flow rate of a fuel injector. In this case, an adjusting element situated close to the magnetic coil outside the flow path of the medium is adjusted. In doing so, the size of the magnetic flux in the magnetic circuit, and thus the magnetic force, changes, so it is possible to influence and adjust the flow rate. The adjustment may be performed with when the fuel injector is either wet or dry.

German Patent Application 42 11 723 A1 describes a fuel injector and a method of adjusting the dynamic flow rate of the medium of a fuel injector, in which an adjusting sleeve having a longitudinal slot is pressed into a longitudinal bore in a connection piece up to a predetermined depth, the dynamic actual flow rate of medium of the injector is measured and compared with a setpoint flow rate of medium, and the pressed-in adjusting sleeve which is under a tension acting radially is advanced until the actual measured flow rate of the medium matches the predetermined setpoint flow rate of the medium.

In German Patent Application 44 31 128 A1, to adjust the dynamic flow rate of medium of a fuel injector, the valve housing undergoes deformation due to the action of a deformation tool on the outer perimeter of the valve housing. This changes the size of the residual air gap between the core and the armature, and thus the magnetic force, so that it is possible to influence and adjust the flow rate of medium.

One disadvantage of the group of methods which influence the magnetic flux in the magnetic circuit is in particular the great expense with regard to manufacturing costs, because the required static flow tolerances must be guaranteed, although this is difficult to implement. In particular, measurements of magnetic fields are complicated to perform and usually require cost-intensive methods and a test field.

One disadvantage of the group of mechanical adjustment methods is in particular the high degree of inaccuracy to which these methods are subject. Furthermore, the opening and closing times of a fuel injector may be shortened only at the expense of electric power, so that the electric load on the components is increased, and the controllers are under greater stress.

In particular, the method known from German Patent Application 44 31 128 A1, where the residual air gap between the core and the armature is varied by deformation of the valve housing, permits only a very inaccurate correction of the flow rate because shear stresses in the nozzle body may have a negative effect on the direction and size of the deforming force. Therefore, a high manufacturing precision is necessary for all parts.

### ADVANTAGES OF THE INVENTION

The fuel injector according to the present invention having the characterizing features of claim 1 and the method according to the present invention for adjusting a fuel injector having the features of claim 21 have the advantage over the related art that due to the introduction of an adjusting body into a sleeve which is pressed into the valve body, it is possible to monitor and adjust the flow rate by a simple mechanical way.

Advantageous refinements of the fuel injector characterized in claim 1 and the method characterized in claim 21 are possible through the measures characterized in the subclaims.

It is advantageous in particular that it is possible to adjust flow rate after the fuel injector has already been installed. The adjusting body is accessible from the outside on its end facing the fuel feed and may be displaced as desired in the sleeve and pushed into the aperture plate by an adjustment bolt after measurement of the actual amount.

The design of the sleeve having a thread which cooperates with a thread provided on the adjusting body is advantageous, so that it is possible to secure the adjusting body in the set position very well. In addition, it is possible to unscrew the adjusting body from the sleeve again to replace it, for example.

The aperture plate, whose cross section may be increased or reduced by-introducing the adjusting body, may also be used in mass-produced fuel injectors. The adjustment of the adjusting body in the sleeve and the manufacture of the adjusting body, the sleeve and the aperture plate may be accomplished by simple means in terms of the manufacturing technology.

It is also advantageous that it is possible to adjust the static and dynamic flow rates separately, so that the preset flow rates need not be altered by further adjustments.

The fact that other adjustment features of the fuel injector are not affected by the adjustment of the flow rate through the sleeve and the adjusting body is also advantageous.

### DRAWING

Embodiments of the present invention are illustrated in simplified form in the drawing and are explained in greater detail in the following description.

FIG. 1 shows a schematic sectional view through an embodiment of a fuel injector according to the related art.

FIG. 2A shows a detail of a schematic section through a first embodiment of the fuel injector according to the present invention in area II in FIG. 1.

FIG. 3 shows a detail of a schematic section through a second embodiment of the fuel injector according to the present invention in area II in FIG. 1.

FIG. 4 shows a detail of a schematic section through a third embodiment of the fuel injector according to the present invention in area II in FIG. 1.

FIG. 5A-C show details of schematic cross sections through the interior part of the third embodiment of the fuel injector according to the present invention along line V-V in FIG. 4 in various embodiments.

FIG. 6A shows a detail of a schematic section through a fourth embodiment of the fuel injector according to the present invention in area II in FIG. 1.

FIG. 6B shows a detailed view of the interior part of the fourth embodiment of the fuel injector according to the present invention.

### DESCRIPTION OF THE EXEMPLARY EMBODIMENTS

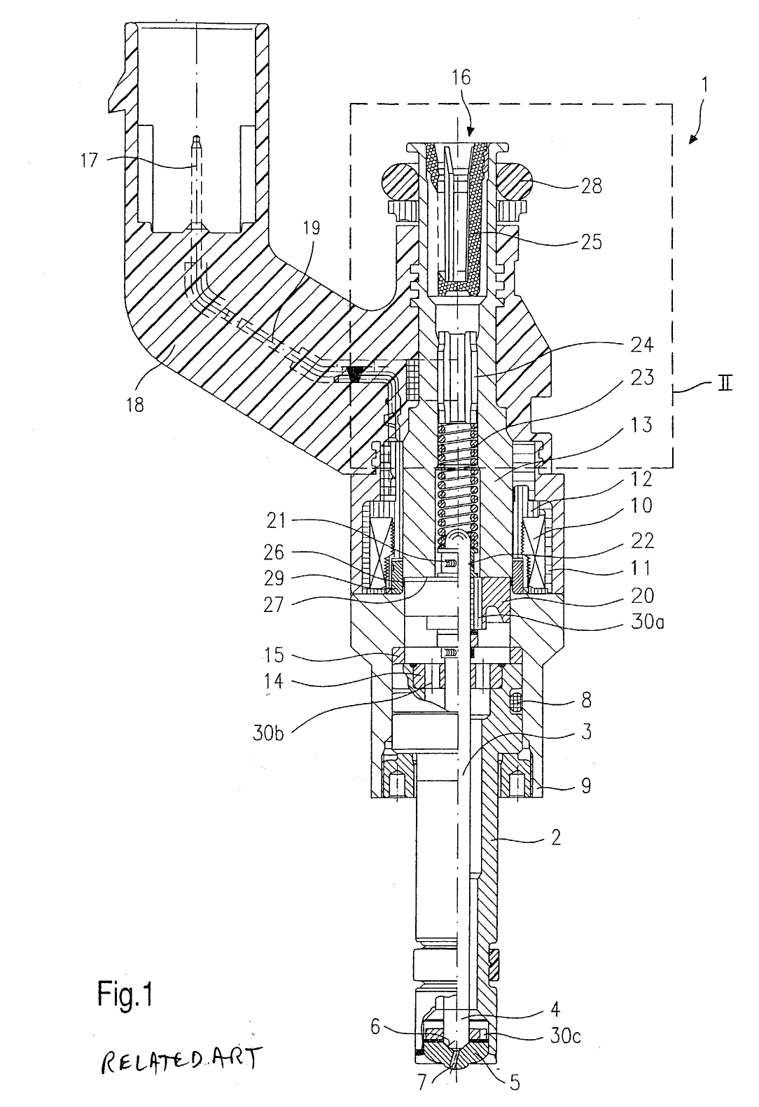

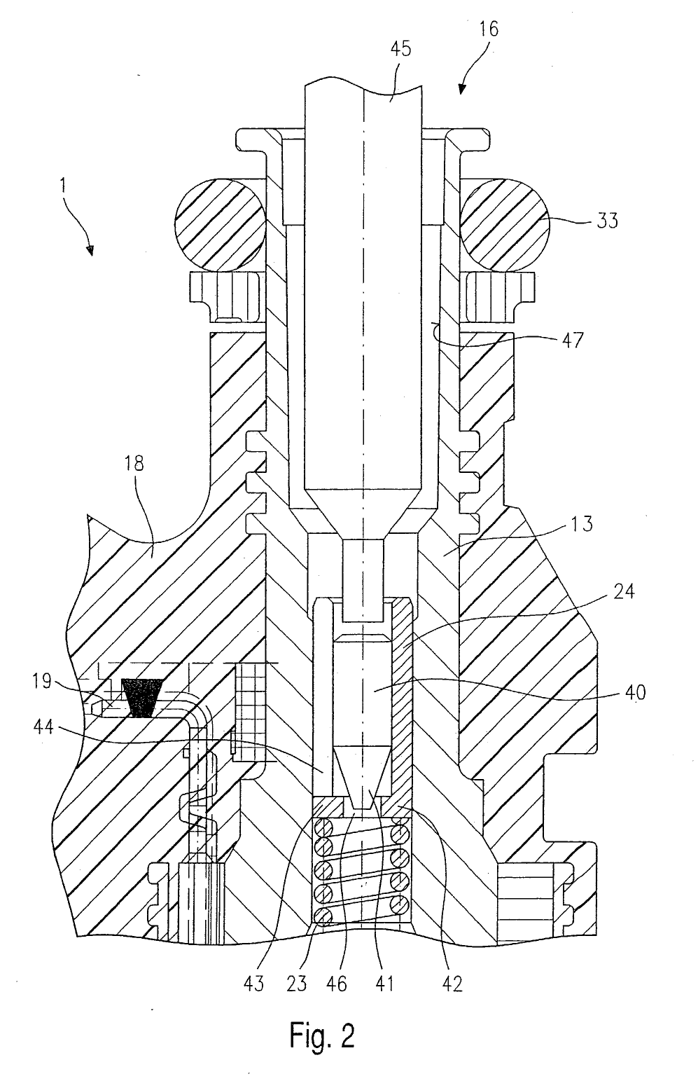

Before describing three embodiments of a fuel injector according to the present invention in greater detail on the basis of FIGS. 2 through 5, a known fuel injector of the same design as in the embodiments, except for the measures according to the present invention, will first be explained briefly with regard to its essential components on the basis of FIG. 1.

Fuel injector 1 is designed in the form of a fuel injector for fuel injection systems of internal combustion engines having spark ignition of a fuel-air mixture. Fuel injector 1 is suitable in particular for direct injection of fuel into a combustion chamber (not shown) of an engine.

Fuel injector 1 has a nozzle body 2 in which a valve needle 3 is guided. Valve needle 3 is mechanically linked to a valve closing body 4 which cooperates with a valve seat face 6 situated on a valve seat body 5 to form a sealing seat. In this embodiment, fuel injector 1 is an inwardly opening fuel injector 1 having an injection orifice 7. Nozzle body 2 is sealed by a seal 8 with respect to stationary pole 9 of a magnetic coil 10. Magnetic coil 10 is encapsulated in a coil housing 11 and is wound on a field spool 12 which is in contact with an internal pole 13 of magnetic coil 10. Internal pole 13 and stationary pole 9 are separated by a gap 26 and are supported on a connecting component 29. Magnetic coil 10 is energized over a line 19 by electric current supplied via an electric plug contact 17. Plug contact 17 is surrounded by a plastic sheathing 18 which may be integrally molded on internal pole 13.

Valve needle 3 is guided in a valve needle guide 14 which is designed in the shape of a disk. A matching adjustment disk 15 is used to adjust the lift. On the other side of adjustment disk 15 there is an armature 20 which is in a friction-locked connection with valve needle 3 via a flange 21, the valve needle being joined to flange 21 by a weld 22. A restoring spring 23 is supported on flange 21; in the present design of fuel injector 1, the restoring spring is pre-stressed by a sleeve 24. Fuel channels 30a through 30c, which carry the fuel that is supplied through a central fuel feed 16 and filtered through a filter element 25 to injection orifice 7, run in valve needle guide 14, armature 20 and on valve seat body 5. Fuel injector 1 is sealed by a seal 28 with respect to a receiving bore (not shown), e.g., in a fuel rail.

In the resting state of fuel injector 1, armature 20 is acted upon by restoring spring 23 against its direction of lift so that valve closing body 4 is held sealingly on valve seat 6. When magnetic coil 10 is energized, it creates a magnetic field which moves armature 20 in the direction of lift against the elastic force of restoring spring 23, the lift being predetermined by a working gap 27 between internal pole 12 and armature 20 in the resting position. Armature 20 also entrains flange 21, which is welded to valve needle 3, in the direction of lift. Valve closing body 4, which is mechanically linked to valve needle 3, is lifted up from the valve seat face, and fuel is injected through injection orifice 7.

When the coil current is turned off, armature 20 drops back from internal pole 13 due to the pressure of restoring spring 23 after the magnetic field has subsided sufficiently, so that flange 21, which is mechanically linked to valve needle 3, moves against the direction of lift. Valve needle 3 is thus moved in the same direction, so that valve closing body 4 is set down on valve seat face 6, and fuel injector 1 is closed.

In an excerpt of a sectional diagram, FIG. 2 shows the detail of fuel injector 1 which is labeled as II in FIG. 1.

The first embodiment of fuel injector 1 according to the present invention illustrated in FIG. 2 shows the inlet-side part of fuel injector 1 without filter element 25, which is present in central fuel feed 16 in FIG. 1. Whereas FIG. 1 shows only sleeve 24, which is needed for adjusting the dynamic fuel flow which is influenced by the opening and closing times, the embodiment illustrated in FIG. 2 also has an adjusting body 40 which is inserted into sleeve 24 and is used for adjusting the static fuel flow, i.e., the flow of fuel in the opened static state. Adjusting body 40 has a cylindrical shape in the present embodiment and is designed with a taper in the form of a truncated cone on injection end 41. On its injection end 42, sleeve 24 is closed by an aperture plate 43. Aperture plate 43 and sleeve 24 may be designed in one piece or they may be manufactured as two different parts. In the present embodiment, sleeve 24 and aperture plate 43 form one overall part. For the sake of facilitating installation, sleeve 24 has a lateral slot 44 which extends as far as aperture plate 43.

To regulate the static fuel flow, adjusting body 40 may be displaced in sleeve 24 in the injection direction using adjustment bolt 45. Then conical injection end 41 of adjusting body 40 is pushed into aperture plate 43. The fuel flow through fuel injector 1 decreases depending on how far injection end 41 of adjusting body 40 projects into a borehole 46 in aperture plate 43.

The dynamic fuel flow is determined by the position of sleeve 24. The further sleeve 24 is pressed into a central recess 47 in fuel injector 1 by a suitable tool (not shown here), the greater is the pre-stress acting on restoring spring 23 and the longer it lasts until fuel injector 1 is opened in the opening operation or the faster fuel injector 1 may be closed in the closing operation. This means that the dynamic fuel flow through fuel injector 1 decreases with an increase in the pre-stress on restoring spring 23 or with an increase in the depth of installation of sleeve 24.

If sleeve 24 is introduced into central recess 47 in a certain desired position, the static fuel flow through fuel injector 1 when the latter is open may be adjusted via adjusting body 40. To determine the proper flow rate and the correct position of adjusting body 40 in sleeve 24, first the actual flow through fuel injector 1 is measured. The actual measured value is then compared with a predetermined setpoint value of the flow rate. Then adjusting body 40 is displaced in sleeve 24 in the direction of injection by adjustment bolt 45 until the actual value matches the setpoint value. Since it is no longer possible to remove adjusting body 40 from sleeve 24, to this end fuel injector 1 must have a static flow rate which is greater than the setpoint value before adjusting the static flow rate.

When the setpoint value for the flow rate through fuel injector 1 has been reached, adjustment bolt 45 is removed and instead filter element 25 is inserted into central recess 47 of fuel injector 1, as illustrated in FIG. 1.

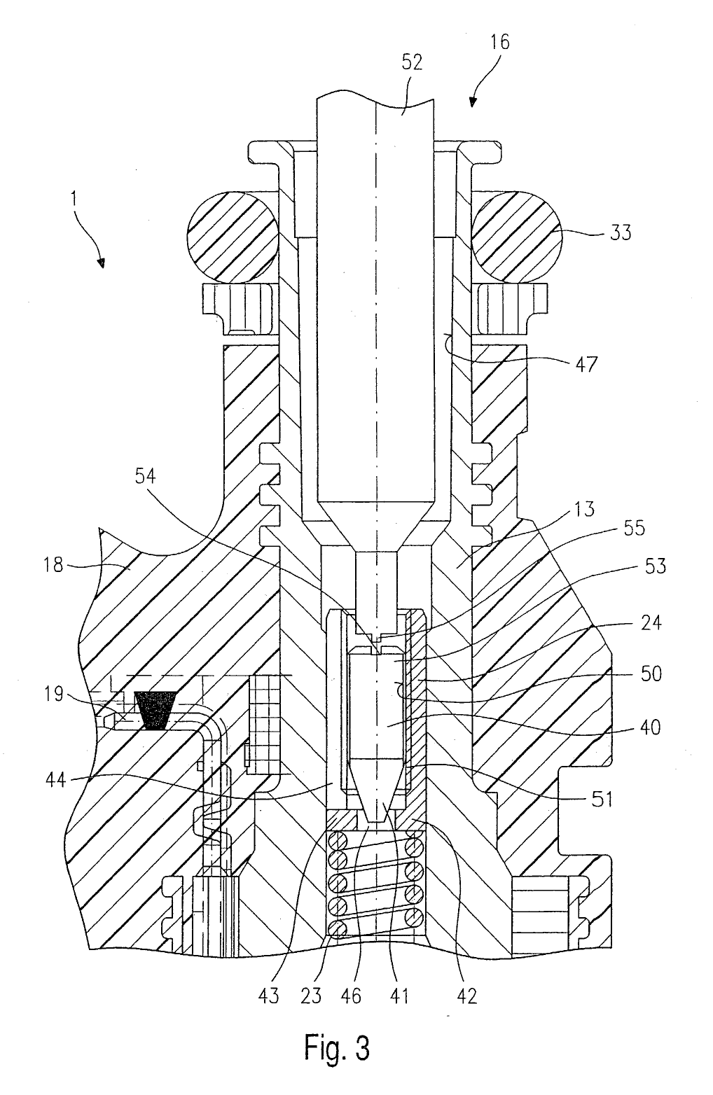

In a detail of a sectional diagram, FIG. 3 shows the detail of a second embodiment of fuel injector 1 which is labeled as II in FIG. 1.

The second embodiment of fuel injector 1 according to the present invention differs from the first embodiment illustrated in FIG. 2 in the design of adjusting body 40 which may be screwed into sleeve 24. To do so, sleeve 24 is provided with an internal thread 51 and adjusting body 40 is provided with an external thread 50. Adjusting body 40 is thus no longer pressed into sleeve 24, but instead is screwed into it by using a suitable adjusting tool 52, e.g., a screwdriver. To this end, an inlet end 53 of adjusting body 40 has a tool groove 54 in which a corresponding projection 55 on adjusting tool 52 engages.

In this embodiment of fuel injector 1 according to the present invention, it is not necessary for the actual flow rate of fuel injector 1 at the beginning of the adjustment to be higher than the setpoint flow rate, because adjusting body 40 may be screwed into any desired position in sleeve 24 via external thread 50 and internal thread 51.

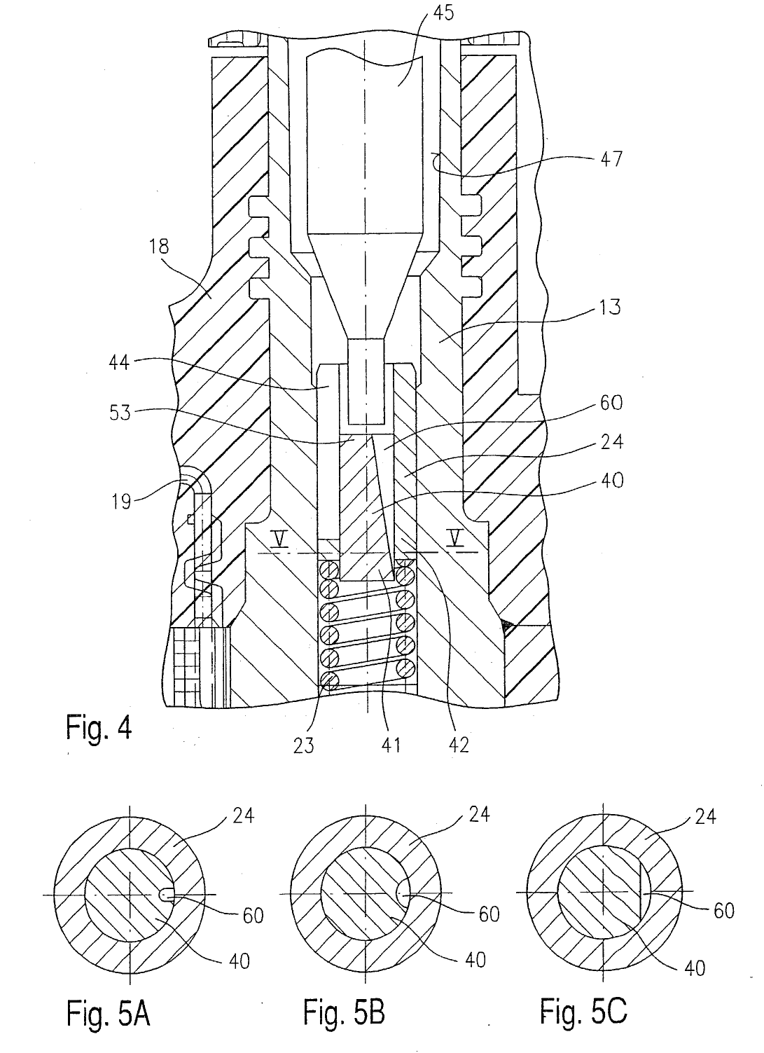

FIG. 4 shows a third embodiment of fuel injector 1 according to the present invention in the detail labeled as II in FIG. 1.

In the present embodiment, sleeve 24 does not have an aperture plate 43, but instead is designed as a hollow cylinder having a side slot 44. Adjusting body 40 is cylindrical and has an axial groove 60 on its outer periphery. Groove 60 may have various cross sections and begins on injection end 41 of adjusting body 40, continuing to inlet end 53 of adjusting body 40 as it becomes wider.

The flow rate through fuel injector 1 is adjusted by a displacement of adjusting body 40 in the direction of injection. In contrast with the embodiments in FIGS. 2 and 3, where the fuel flow rate through fuel injector 1 decreases with an increase in the depth to which adjusting body 40 is screwed or pressed into sleeve 24, in the present embodiment the flow rate increases with an increase in the depth of insertion of adjusting body 40.

When adjusting body 40 is inserted into sleeve 24 and has been pushed in to the extent that injection end 41 of adjusting body 40 and injection end 41 of sleeve 24 are flush with one another, there is only minimal fuel flow through fuel injector 1 or none at all. The further adjusting body 40 is pressed through sleeve 24 in the direction of injection, the greater is the wetted cross section made available for flow through groove 60.

This arrangement has the advantage that the flow rate need not be measured repeatedly and compared with the setpoint value, but instead adjusting body 40 is pushed continuously further into sleeve 24 until the actual value of fuel flow 1 matches the setpoint value.

FIGS. 5A-SC show cross sections through injection end 41, 42 of adjusting body 40 and sleeve 24 along line V-V. In adjusting body 40, which fills up sleeve 24, groove 60 is designed so that fuel flows through it in the direction of the valve seat.

Groove 60 may have various cross sections. In the first embodiment, which is illustrated in FIG. 5A, groove 60 is U-shaped, while the embodiment illustrated in FIG. 5B has a C-shaped groove 60.

The embodiment illustrated in FIG. 5C, which has a flattened planar area 60 instead of groove 60, is especially simple to manufacture. Adjusting body 40 thus assumes the shape of a notched cylinder.

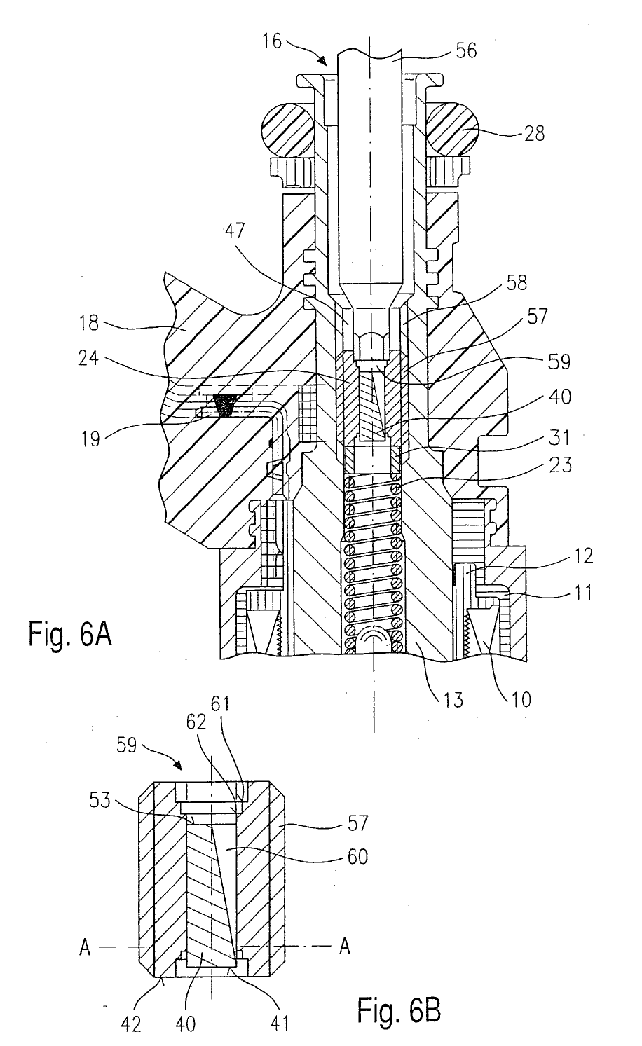

FIG. 6A shows a fourth embodiment of fuel injector 1 according to the present invention. In contrast with preceding embodiments, sleeve 24 has an external thread 57 which cooperates with an internal thread 58 of central recess 47 of fuel injector 1. The position of sleeve 24 in central recess 47 of fuel injector 1 may thus be adjusted by turning it by using a suitable adjusting tool 56. The inlet end of sleeve 24 has a two-step recess 59, the diameter of which tapers in two steps 61 and 62 in the direction of the fuel flow.

In the direction of injection, sleeve 24 is supported on an intermediate sleeve 31 which is clamped between sleeve 24 and restoring spring 23. This results in no rotational force being applied to restoring spring 23 when screwing in sleeve 24, thus preventing metal shavings from being removed and also preventing the resulting contamination of fuel injector 1.

The dynamic fuel flow is defined by the position of sleeve 24, as already explained above. The further sleeve 24 is screwed into central recess 47 of fuel injector 1 using adjusting tool 56, which may be a hexagon socket wrench, for example, the greater is the pre-stress acting upon restoring spring 23, and the longer it takes for fuel injector 1 to be opened in the opening operation and the more rapidly fuel injector 1 may be closed in the closing operation. This means that the dynamic fuel flow through fuel injector 1 decreases with an increase in the pre-stress of restoring spring 23 and with an increase in the depth of installation of sleeve 24. Tool 56 then engages in recess 59 in sleeve 24 at the first step 61. The position of adjusting body 40 in sleeve 24 is not affected by screwing in sleeve 24 using adjusting tool 52.

When sleeve 24 is brought into a certain desired position in central recess 47, the static fuel flow which flows through fuel injector 1 when the latter is opened may be adjusted via adjusting body 40. In the present embodiment this second adjustment step is identical to the procedure illustrated in FIG. 4. Only stepped recess 59 in sleeve 24 is different, because adjusting body 40 is displaced by tool 45, which has a smaller diameter than adjusting tool 56. Adjusting tool 45 thus acts on second step 62, without influencing the adjustment of sleeve 24 in recess 47 of fuel injector 1. Sleeve 24 having external thread 57 may be combined with any desired adjusting body 40, in particular with adjusting bodies 40 described in conjunction with FIGS. 2 and 3. Thus, for example, an embodiment in which the positions of sleeve 24 as well as adjusting body 40 may be varied by turning them by using suitable adjusting tools 56 and 52 is possible.

The present invention is not limited to the embodiments presented here and it is suitable for any designs of fuel injectors 1, e.g., for fuel injectors 1 having piezoelectric or magnetostrictive actuators or outwardly opening fuel injectors 1.

What is claimed is:

1. A fuel injector (1) for fuel injection systems of internal combustion engines, in particular for direct injection of fuel into the combustion chamber of an engine, comprising an actuator (10), a valve needle (3) which is mechanically linked to the actuator (10) and is acted upon by a restoring spring (23) in a closing direction, to actuate a valve closing body (4), which, together with a valve seat face (6), forms a sealing seat, and comprising a sleeve (24) which pre-stresses the restoring spring (23),
wherein an adjusting body (40) is mounted so as to be ajdustable in the sleeve (24) so that a fuel amount flowing through the fuel injector (1) per unit of time is dependent upon the position of the adjusting body (40) in the sleeve (24).

2. The fuel injector according to claim 1, wherein the sleeve (24) is inserted into a central recess (47) in the fuel injector (1).

3. The fuel injector according to claim 1 or 2, wherein the restoring spring (23) is supported on an injection end (42) of the sleeve (24).

4. The fuel injector according to claim 2, wherein the position of the adjusting body (40) is variable in the sleeve (24) via a first adjusting tool (45, 52).

5. The fuel injector according to one of claims 1 through 4, wherein an injection end (41) of the adjusting body (40) is designed with a conical shape.

6. The fuel injector according to claim 5, wherein the sleeve (24) has an aperture plate (43) on its injection end (42).

7. The fuel injector according to claim 6, wherein the conical end (41) of the adjusting body (40) projects into a borehole (46) in the aperture plate (43).

8. The fuel injector according to one of claims 1 through 7, wherein the sleeve (24) and the adjusting body (40) each have a thread (50, 51).

9. The fuel injector according to claim 8, wherein the position of the adjusting body (40) in the sleeve (24) is adjustable by turning it using a first adjusting tool (52).

10. The fuel injector according to one of claims 1 through 4, wherein the adjusting body (40) is cylindrical in shape.

11. The fuel injector according to claim 10, wherein the cylindrical adjusting body (40) has a groove (60) which extends in the axial direction in the outside wall of the adjusting body (40).

12. The fuel injector according to claim 11, wherein the radial dimension of the groove (60) increases from the injection end (41) of the adjusting body (40) to an inlet end (53) of the adjusting body (40).

13. The fuel injector according to claim 12, wherein the groove (60) is U-shaped.

14. The fuel injector according to claim 12, wherein the groove (60) is C-shaped.

15. The fuel injector according to claim 10, wherein the cylindrical adjusting body (40) has a planar area (60) which extends in the axial direction on the outside wall of the adjusting body (40).

16. The fuel injector according to claim 4, wherein the sleeve (24) has an external thread (57) which cooperates with an internal thread (58) of the central recess (47) in the fuel injector (1) and is adjustable by a second adjusting tool (56).

17. The fuel injector according to claim 16, wherein the sleeve (24) has a recess (59) on the inlet side in which the first adjusting tool (45) and the second adjusting tool (56) are engaged.

18. The fuel injector according to claim 17, wherein the recess (59) on the inlet side is designed to have two steps, the second adjusting tool (56) being insertable up to a first step (61) and the first adjusting tool (45) being insertable up to a second step (62).

19. The fuel injector according to one of claims 1 through 18, wherein the sleeve (24) is supported on an intermediate sleeve (31).

20. The fuel injector according to claim 19, wherein the intermediate sleeve (31) is clamped between the sleeve (24) and the restoring spring (23).

21. A method of adjusting a fuel injector (1) for fuel injection systems of internal combustion engines, in particular for direct injection of fuel into the combustion chamber of an engine, having an actuator (10), a valve needle (3) which is acted upon by a restoring spring (23) in a closing direction and is mechanically linked to an actuator (10) to actuate a valve closing body (4) which, together with a valve seat face (6), forms a sealing seat, and a sleeve (24) which pre-stresses the restoring spring (23), an adjusting body (40) being mounted so as to be adjustable in the sleeve (24), so that the fuel flow rate flowing through the fuel injector (1) per unit of time is dependent upon the position of the adjusting body (40) in the sleeve (24), comprising the following steps:
measuring a static actual flow through the fuel injector (1);
comparing the measured static actual flow rate with a static setpoint flow rate; and
adjusting the adjusting body (40) in the sleeve (24) until the actual flow rate corresponds to the static setpoint flow rate.

22. The method according to claim 21, wherein the adjusting body (40) is adjusted in the sleeve (24) by turning it using a first adjusting tool (52).

23. The method according to claim 21, wherein the adjusting body (40) is adjusted in the sleeve (24) by pressing it in using an adjusting bolt (45).

24. The method according to one of claims 21 through 23, wherein the adjustment of the static flow rate by the adjusting body (40) and the adjustment of a dynamic flow rate by axial displacement of the sleeve (24) are performed independently of one another.

25. The method according to claim 24, wherein the axial displacement of the sleeve (24) is performed by turning it using a second adjusting tool (56).
